(19) United States
(12) Patent Application Publication
(10) Pub. No.: US 2019/0138546 A1
(43) Pub. Date: May 9, 2019

(54) METHOD FOR AUTOMATICALLY TAGGING METADATA TO MUSIC CONTENT USING MACHINE LEARNING

(71) Applicant: ARTISTS CARD INC., Seongnam-si (KR)

(72) Inventor: Yun Sung JUNG, Seoul (KR)

(73) Assignee: ARTISTS CARD INC., Seongnam-si (KR)

(21) Appl. No.: 16/203,117

(22) Filed: Nov. 28, 2018

Related U.S. Application Data
(63) Continuation of application No. PCT/KR2018/013170, filed on Nov. 1, 2018.

(30) Foreign Application Priority Data
Nov. 6, 2017 (KR) 10-2017-0146540

(51) Int. Cl. G06F 16/583; G06F 16/951; G06F 16/535; G06N 20/00

(52) U.S. Cl. CPC G06F 16/583; G06N 20/00; G06F 16/535; G06F 16/951

(57) ABSTRACT

Provided is a method for automatically tagging metadata to music content using machine learning. The method includes generating a model for automatically tagging metadata, obtaining at least one audio analysis result value for predetermined music content, and automatically tagging metadata to the predetermined music content based on the at least one audio analysis result value for the predetermined music content using the model for automatically tagging metadata, wherein training data for the machine learning includes at least one audio analysis result value for at least one training music content, and metadata tagged to the at least one training music content, and wherein the metadata includes information data, emotion-related data, and user experience-related data.

### CROSS-REFERENCE TO RELATED APPLICATIONS

The present application is a continuation of International Patent Application No. PCT/KR2018/013170, filed on Nov. 1, 2018, which is based upon and claims the benefit of priority to Korean Patent Application No. 10-2017-0146540, filed on Nov. 6, 2017. The disclosures of the above-listed applications are hereby incorporated by reference herein in their entirety.

### BACKGROUND

Embodiments of the inventive concept relate to metadata tagging, and more particularly, a method for automatically tagging metadata to music content.

A user interface is changing from touch-based to voice-based. An artificial intelligence (AI) speaker, which is being released all over the world recently, announces the beginning of a such change. The voice-based user interface is expected to be a post user interface for various devices such as personal and household devices, and vehicle infotainment as well as the speaker.

Music is a representative area of various fields requiring the voice-based user interface. A user wants a music playlist to be automatically recommended and played, with a few words of voice, to match his or her own preferences. To this end, it is important to design a music data set refined based on big data, and to generate a music recommendation model using the designed music data set and machine learning.

A conventional music streaming service employs a recommendation algorithm that uses vulnerable information, such as a title and an artist name, and employs inaccurate emotion-related data via morphological analysis and user tagging. However, such a recommendation algorithm provides a playlist of songs that are not the songs the user wanted, that is a response that does not match the user's request. In order to solve this problem, it is necessary for a human to manually curate the music wanted by the user to generate a music playlist.

### SUMMARY

Embodiments of the inventive concept provide a method for automatically tagging metadata to music content.

Purposes to be achieved by the inventive concept are not limited to purposes mentioned above, and other purposes not mentioned may be clearly understood by those skilled in the art from following descriptions.

According to an aspect of an embodiment, a method for automatically tagging metadata to music content using machine learning, the method includes generating a model for automatically tagging metadata, obtaining at least one audio analysis result value for predetermined music content, and automatically tagging metadata to the predetermined music content based on the at least one audio analysis result value for the predetermined music content, using the model for automatically tagging metadata, wherein training data for the machine learning includes at least one audio analysis result value for at least one training music content, and metadata tagged to the at least one training music content, and wherein the metadata includes information data, emotion-related data, and user experience-related data.

According to another aspect of an embodiment, the automatically tagging metadata to the predetermined music content includes tagging the information data to the predetermined music content based on at least one first audio analysis result value among the at least one audio analysis result value for the predetermined music content, tagging the emotion-related data to the predetermined music content based on at least one second audio analysis result value among the at least one audio analysis result value for the predetermined music content, and tagging the user experience-related data to the predetermined music content based on at least one third audio analysis result value among the at least one audio analysis result value for the predetermined music content.

According to another aspect of an embodiment, the information data or the emotion-related data of the training data is obtained via web crawling.

According to another aspect of an embodiment, the information data of the training data includes at least one of artist information, work information, track information, and musical instrument information of the training music content.

According to another aspect of an embodiment, the user experience-related data of the training data is information about a pattern of music content used by at least one user of predetermined music content playback service, wherein the user experience-related data is obtained based on at least one of artist information, genre information, musical instrument information, and emotion information of the music content.

According to another aspect of an embodiment, the user experience-related data includes at least one profile information about a user who prefers the training music content.

According to another aspect of an embodiment, the at least one audio analysis result value is provided in a key-value data structure, and wherein generating the model for automatically tagging metadata includes defining at least one key corresponding the at least one audio analysis result for the at least one training music content as the training data.

According to another aspect of an embodiment, the generating a model for automatically tagging metadata using the machine learning includes training the information data of the metadata using a binary classification scheme.

According to another aspect of an embodiment, the generating a model for automatically tagging metadata using the machine learning includes training the emotion-related data of the metadata using a regression scheme.

Other specific details of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 is a flowchart schematically illustrating a method for automatically tagging metadata to music content according to an embodiment of the inventive concept;

FIG. 2 is a schematic diagram illustrating an overall process of a method for automatically tagging metadata to music content according to an embodiment of the inventive concept;

FIG. 3 is a conceptual diagram illustrating a structure of music content of FIG. 2;

FIG. 4 is a conceptual diagram illustrating an audio analysis of training music content;

FIG. 5 is a flowchart schematically illustrating a detailed operation of an operation (S130) of FIG. 1; and

FIG. 6 is a conceptual diagram illustrating that a music playlist composed by using metadata tagged music content is provided to a user via streaming or API service.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are only provided to make the disclosure of the inventive concept complete and fully inform those skilled in the art to which the inventive concept pertains of the scope of the inventive concept. The inventive concept is only defined by scopes of claim.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. The same reference numerals denote like components, “and/or” throughout the specification includes each and every combination of one or more of the components mentioned. In the following description, although the terms “first”, “second”, and the like are used to describe various components, but are not construed to be limited by these terms. These terms are only used to distinguish one component from another. Thus, “a first component” mentioned below may be “a second component” within the technical sprit of the inventive concept.

Unless otherwise defined, all terms including technical and scientific terms used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Herein, a term “machine learning” refers to training a computer using data. A computer that has gone through the machine learning may judge, and predict new unknown data by itself, and perform an appropriate task. The machine learning may be largely divided into a supervised learning, an unsupervised learning, and a reinforcement learning.

A term “metadata” refers to structured or unstructured data about predetermined data given for representing attributes, and the like of other data. The metadata may be used for purposes of representing related data, or for searching for the related data, but is not limited thereto.

A term “tagging” refers to granting the metadata to the predetermined data, or refers to such an action. A plurality of the metadata may be tagged to one data.

Hereinafter, embodiments of the inventive concept will be described in detail with reference to the accompanying drawings.

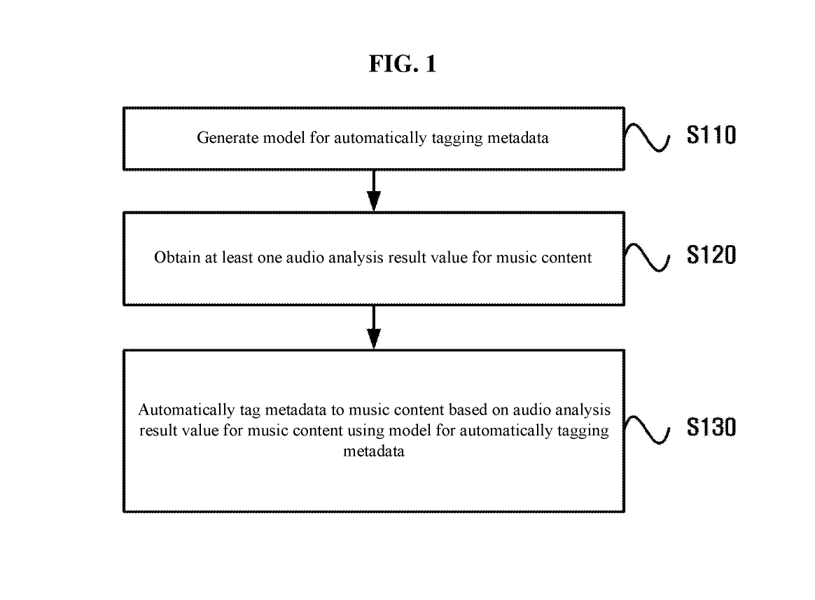

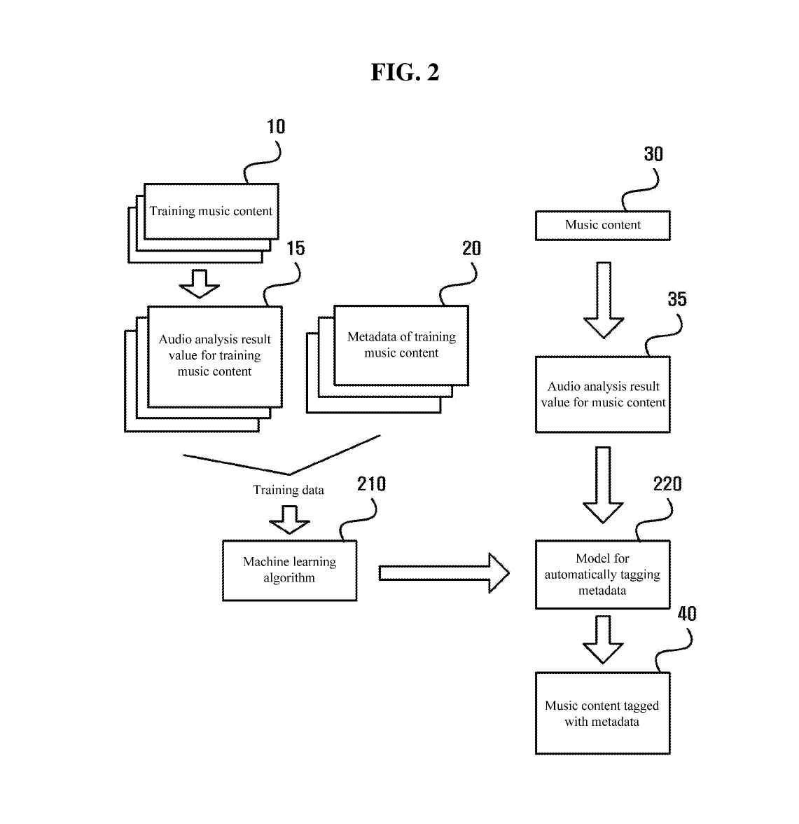

FIG. 1 is a flowchart schematically illustrating a method for automatically tagging metadata to music content according to an embodiment of the inventive concept. In addition, FIG. 2 is a schematic diagram illustrating an overall process of a method for automatically tagging metadata to music content according to an embodiment of the inventive concept.

With reference to FIG. 1 and FIG. 2, a method for automatically tagging metadata to music content according to an embodiment of the inventive concept includes: generating a model for automatically tagging metadata (S110); obtaining at least one audio analysis result value for predetermined music content (S120); and automatically tagging metadata to the predetermined music content based on the at least one audio analysis result value for the predetermined music content using the model for automatically tagging metadata (S130).

In operation S110, the model for automatically tagging metadata 220 is generated using the machine learning. In this connection, training data for the machine learning includes at least one audio analysis result value 15 of at least one training music content 10, and metadata 20 tagged to the at least one training music content 10. The training music content 10 represents music content included in the training data for training the computer.

The metadata 20 includes information data, emotion-related data, and user experience-related data. In some embodiments, the metadata 20 may further include other data not illustrated.

In some embodiments, the information data may include at least one of artist information, work information, track information, and musical instrument information of the training music content, but is not limited thereto. An artist includes both a creator of music content (e.g. a composer, a lyricist, and the like) and a performer (e.g. a singer, a player, a conductor, and the like).

In some embodiments, the emotion-related data indicates emotion that is inherent in, and expressed by the training music content. The emotion-related data may be classified into a situation, a place, a season, a weather, a feeling, a mood, a style, and the like.

In some embodiments, the information data and the emotion-related data may be obtained via web crawling, but are not limited thereto. Context analysis and classification operations may be further performed to obtain the emotion-related data.

In some embodiments, the user experience-related data may be obtained from information about a pattern of music content used by at least one user via music content playback service (for example, streaming or API). For example, the user experience-related data may be acquired based on at least one of artist information, genre information, musical instrument information, and emotion information of the music content, but is not limited thereto. In some embodiments, the user experience-related data may include at least one profile information (for example, age, gender, region, occupation, and the like) about a user who prefers the training music content. That is, the user experience-related data indicates which type of user prefers the training music content.

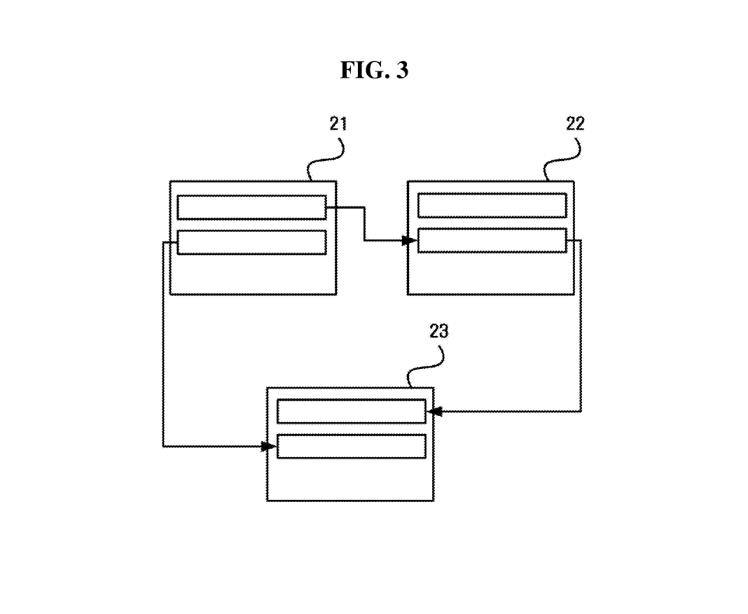

FIG. 3 is a conceptual diagram illustrating a structure of the music content of FIG. 2.

With reference to FIG. 3, the metadata 20 of the training music content 10 of FIG. 2 may be provided as a relational database (RDB).

In some embodiments, for example, the information data of the training music content 10 may be provided as a relational database. The information data of the training music content 10 may be composed of one or more tables 21 to 23 having 1:1, 1:N, or N:N relationship. For example, a table 21 may include the artist information, a table 22 may include the work information, and a table 23 may include the track information, the musical instrument information, and the like. Then, a predetermined artist included in the table 21 may be mapped to a predetermined work of the table 22, and a predetermined artist included in the table 21 may be mapped to a predetermined track of the table 23. Further, a predetermined work in the table 22 may be mapped to a predetermined track of the table 23.

In one example, in some embodiments, the emotion-related data or the user experience-related data of the training music content 10 may also be provided as the relational database.

Further, in some embodiments, the metadata 20 of the training music content may be provided as the relational database. That is, each of databases of the information data, the emotion-related data, and the user experience-related data may be correlated.

A relational database management system (RDBMS) may be provided to manage these relational databases.

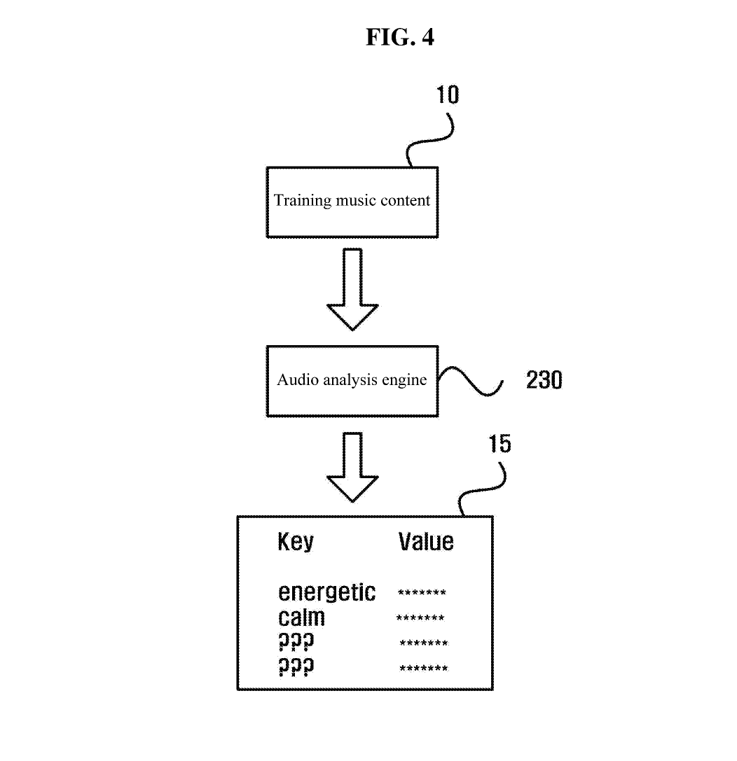

FIG. 4 is a conceptual diagram illustrating an audio analysis of the training music content.

With reference to FIG. 4, an audio analysis engine 230 analyzes the training music content 10 to generate at least one audio analysis result value 15 of the training music content 10. The at least one audio analysis result value 15 is extracted feature of the training music content. The audio analysis result value 15 may include, for example, a phase, a frequency, an amplitude, and a repeated pattern, but is not limited thereto.

In some embodiments, the at least one audio analysis result value 15 is provided in a key-value data structure. Then, a dictionary operation may be performed such that at least one key corresponding the at least one audio analysis result value 15 of the at least one training music content 10 is defined.

The at least one audio analysis result value 15, as described above, may include a phase, a frequency, an amplitude, a repeated pattern, and the like. Further, the at least one audio analysis result value 15 may include an analysis result value in an unstructured data format that is difficult to be clearly defined. Therefore, the dictionary operation for defining each key of the audio analysis result value 15 as a human-understandable language is required. For example, the at least one key corresponding the audio analysis result value 15 may be defined as exciting, happy, relaxed, peaceful, joyful, powerful, gentle, sad, nervous, angry, and the like, but is not limited thereto. The illustrated dictionary operation is about the emotion-related data. Further, a dictionary operation about the information data, or about the user experience-related data may also be provided separately. A result of the dictionary operation may be used for validation of the machine learning.

The machine learning algorithm 210 generates the model for automatically tagging metadata 220 using the at least one audio analysis result value 15 of the at least one training music content 10, and the metadata 20 tagged to the at least one training music content 10 as the training data. At this time, the machine learning algorithm 210 learns the information data of the metadata 20 by a binary classification scheme. In addition, the machine learning algorithm 210 learns the emotion-related data of the metadata 20 by a regression scheme. This takes into account the nature of the data being learned. The binary classification scheme represents a scheme of classifying given training data into discrete classes or groups depending on their characteristics. In addition, the regression scheme represents a scheme of deriving continuous data depending on characteristics of given training data.

In operation S120, the audio analysis engine 230 analyzes predetermined music content 30 to generate at least one audio analysis result value 35 of the predetermined music content 30.

In operation S130, the model for automatically tagging metadata 220 automatically tags metadata on the predetermined music content 30 based on the at least one audio analysis result value 35 of the predetermined music content 30. That is, the model for automatically tagging metadata 220 receives the at least one audio analysis result value 35 of the predetermined music content 30 and outputs the predetermined music content 40 tagged with the metadata.

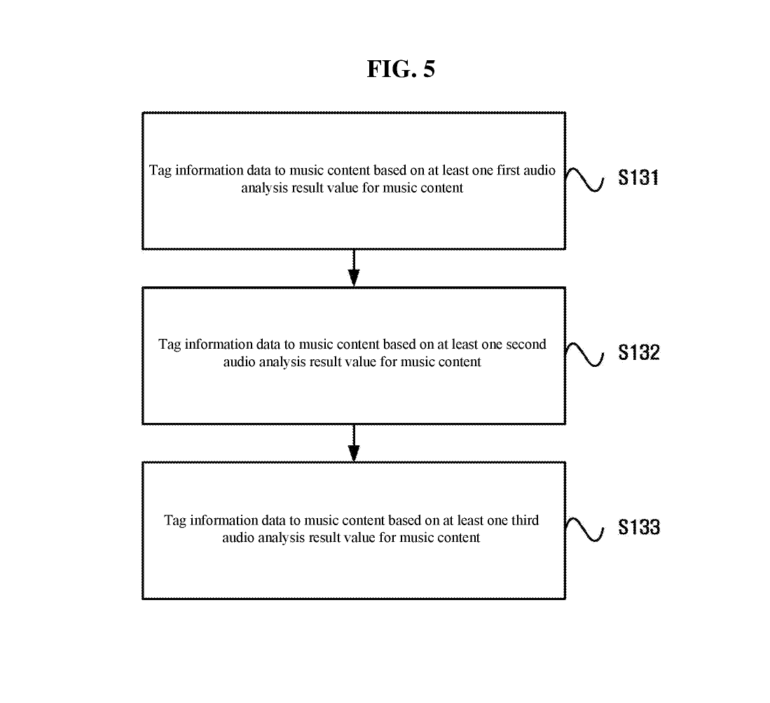

FIG. 5 is a flowchart schematically illustrating a detailed operation of the operation S130 of FIG. 1.

With reference to FIG. 5, in some embodiments, operation S130 of FIG. 1 includes tagging the information data to the predetermined music content based on at least one first audio analysis result value among the at least one audio analysis result value for the predetermined music content (S131), tagging the emotion-related data to the predetermined music content based on at least one second audio analysis result value among the at least one audio analysis result value for the predetermined music content (S132), and tagging the user experience-related data to the predetermined music content based on at least one third audio analysis result value among the at least one audio analysis result value for the predetermined music content (S133).

That is, tagging of the information data, tagging of the emotion-related data, and tagging of the user experience-related data may be performed independently of each other. In addition, at least one audio analysis result value, which is referred for tagging each data, may be the same, partially overlapped, or different from each other.

In one example, in an absence of an appropriate class or value, one or more of the information data, the emotion-related data, or the user experience-related data may not be tagged. That is, at least one of the information data, the emotion-related data, and the user experience-related data of the metadata to the predetermined music content may be recorded as empty.

In some embodiments, unlike as shown in FIG. 5, at least a part of operations S131, S132, and S133 may be performed at the same time.

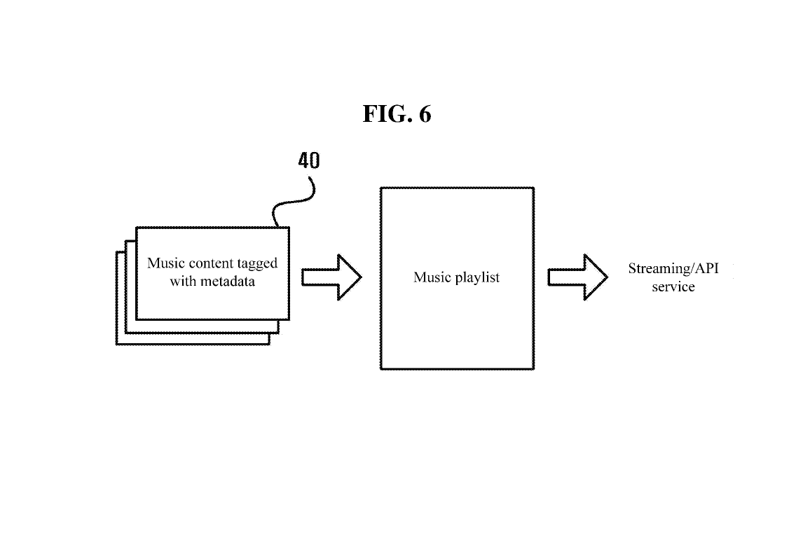

FIG. 6 is a conceptual diagram illustrating that a music playlist composed by using metadata tagged music content is provided to a user via streaming or API service.

With reference to FIG. 6, with the metadata tagged music content 40, a music playlist desired by the user may be generated automatically. The music playlist thus generated may be recommended and provided to the user via streaming or API service.

In some embodiments, the above-discussed method of FIG. 1, 5 according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 1, 5 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the method for automatically tagging metadata to music content of the inventive concept described above, a model for automatically tagging metadata using machine learning based on extensive training data composed of at least one audio analysis result value for at least one training music content, and metadata including information data, emotion-related data, and user experience-related data tagged to the at least one training music content is generated, so that metadata may be automatically tagged quickly to a new music content.

Further, according to the method for automatically tagging metadata to music content of the inventive concept described above, the at least one analysis result value for the music content is provided in a key-value data structure, and a dictionary operation for defining at least one key corresponding the at least one analysis result value is performed, so that validated metadata may also be tagged to a new music content.

Further, according to the method for automatically tagging metadata to music content of the inventive concept described above, a music playlist desired by a user is automatically composed and recommended using the music content quickly and accurately tagged with the validated metadata, so that a response that matches the user's request may be provided.

The operations of a method or algorithm described in connection with the embodiment of the inventive concept may be embodied directly in a hardware module (computer or a component of the computer), or in a software module (computer program executed by the hardware module, an application program, a firmware, or the like), or a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or any form of computer readable recording medium well known in the art to which the inventive concept belongs.

While the embodiments of the inventive concept has been described with reference to the accompanying drawings, it will be apparent to those skilled in the art that various changes and modifications may be made without departing from the spirit and scope of the inventive concept. Therefore, it should be understood that the above embodiments are not limiting, but illustrative.

What is claimed is:

1. A method for automatically tagging metadata to music content using machine learning, the method comprising:
generating a model for automatically tagging metadata;
obtaining at least one audio analysis result value for predetermined music content; and
automatically tagging metadata to the predetermined music content based on the at least one audio analysis result value for the predetermined music content, using the model for automatically tagging metadata,
wherein training data for the machine learning includes:
at least one audio analysis result value for at least one training music content; and
metadata tagged to the at least one training music content, and
wherein the metadata includes information data, emotion-related data, and user experience-related data.

2. The method of claim 1, wherein the automatically tagging metadata to the predetermined music content includes:
tagging the information data to the predetermined music content based on at least one first audio analysis result value among the at least one audio analysis result value for the predetermined music content;
tagging the emotion-related data to the predetermined music content based on at least one second audio analysis result value among the at least one audio analysis result value for the predetermined music content; and
tagging the user experience-related data to the predetermined music content based on at least one third audio analysis result value among the at least one audio analysis result value for the predetermined music content.

3. The method of claim 1, wherein the information data or the emotion-related data of the training data is obtained via web crawling.

4. The method of claim 1, wherein the information data of the training data includes at least one of artist information, work information, track information, and musical instrument information of the training music content.

5. The method of claim 1, wherein the user experience-related data of the training data is information about a pattern of music content used by at least one user of predetermined music content playback service,
wherein the user experience-related data is obtained based on at least one of artist information, genre information, musical instrument information, and emotion information of the music content.

6. The method of claim 1, wherein the user experience-related data includes at least one profile information about a user who prefers the training music content.

7. The method of claim 1, wherein the at least one audio analysis result value is provided in a key-value data structure, and
wherein generating the model for automatically tagging metadata includes defining at least one key corresponding to the at least one audio analysis result for the at least one training music content as the training data.

8. The method of claim 1, wherein the generating a model for automatically tagging metadata using the machine learning includes training the information data of the metadata using a binary classification scheme.

9. The method of claim 1, wherein the generating a model for automatically tagging metadata using the machine learning includes training the emotion-related data of the metadata using a regression scheme.

10. A computer program stored on a computer readable recording medium, wherein when the program is coupled to a computer device, the program is configured to perform the method of claim 1.
